(19) United States
(12) Patent Application Publication
(10) Pub. No.: US 2006/0273249 A1
(43) Pub. Date: Dec. 7, 2006

(54) Image sensor chip package and method of manufacturing the same

(75) Inventors: Steven Webster, Miao-li (TW); Ying-Cheng Wu, Miao-li (TW); Po-Chih Hsu, Miao-li (TW); Kun-Hsieh Liu, Miao-li (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ALTUS TECHNOLOGY INC., Miao-li Hsien (TW)

(21) Appl. No.: 11/398,023

(22) Filed: Apr. 4, 2006

(30) Foreign Application Priority Data
Jun. 3, 2005 (CN) 200510035138.6

(51) Int. Cl. H01J 5/02

(52) U.S. Cl. 250/239

(57) ABSTRACT

An image sensor chip package (200) includes a base (20), an image sensor chip (23), a plurality of wires (24), an adhesive means (26) and a cover (28). The base has a top surface (201) and a plurality of top pads (204) arranged on the top surface. The image sensor chip is mounted on the top surface of the base and includes a photosensitive area (231) and a plurality of chip pads (232) around the photosensitive area. The wires electrically connect the chip pads of image sensor chip and the top pads of the base. The adhesive means is applied on peripheral edge of the image sensor chip, over the wires and covers areas where the wires connecting with the chip pads. The cover is transparent and is mounted to the image sensor chip via the adhesive means. The cover seals the photosensitive area of the image sensor chip.

### BACKGROUND OF THE INVENTION

1. Field of the Invention

The present invention generally relates to an IC (Integrated Circuit) chip package and its method of manufacture and, more particularly, to a small sized image sensor chip package and its method of manufacture.

2. Discussion of the Related Art

Image sensors are widely used in digital camera modules in order to convert the optical image data of an object into electrical signals. In order to protect the image sensor from contamination or pollution (i.e. from dust or water), the image sensor is generally sealed in a structural package.

A typical image sensor chip package 100 is illustrated in FIG. 1. The image sensor chip package 100 is constructed to include a base 10, a chip 12, adhesive means 13 and a cover 14. The base 10 includes a bottom board 101 and a side wall 102 peripherally protruding from a top surface of the bottom board 101. The bottom board 101 and the side wall 102 together define a receiving chamber 103 therebetween. A plurality of top pads 104 are arranged on the top surface of the bottom board 101. A plurality of bottom pads 105 are arranged on a bottom surface of the bottom board 101. A plurality of interconnection pads 106 are embedded in the bottom board 101. One end of each interconnection pad 106 electrically connects with a corresponding top pad 104 and the other end of each interconnection pad 106 electrically connects with a corresponding bottom pad 105, in order to electrically connect the top pads 104 to the bottom pads 105. The chip 12 is securely mounted on the top surface of the bottom board 101, being surrounded by the top pads 104 and received in the receiving chamber 103. The chip 12 has an active area 121 on a top side thereof and a plurality of chip pads 122 disposed around the active area 121. Each chip pad 122 is electrically connected with a corresponding top pad 104 via a respective bonding wire 123. An adhesive means 13 is applied around the chip 12, and covers the top pads 104 and the chip pads 122. The adhesive means 13 is also applied on the top of the side wall 102. The cover 14 is transparent and secured to the top of the side wall 102 via the adhesive means 13, thereby hermetically sealing the receiving chamber 103 and allowing light beams to pass therethrough.

In the image sensor chip package 100, the top surface of the bottom board 101 peripherally surrounded by the side wall 102 must contain the top pads 104 and the chip 12 together, and sufficient space should be provided between the chip 12 and the side wall 102 for movement of wire bonding tools used to connect the bonding wires 123 with the top pads 104 and the chip pads 122. Therefore, package volume for packaging the chip 12 is a lot larger than that taken up by the chip 12. As such, the image sensor chip package 100 is not suitable for slim, compact electronic products.

In addition, the relative large volume of the image sensor chip package 100 results in more particles adhering to the cover 14, the bottom board 101 and the side wall 102 of the base 10. The particles obscure the optical path and produce errors in the image sensing process. Accordingly, the quality and/or reliability of the image sensor chip package 100 is effected.

What is needed, therefore, is an image sensor chip package with small size, reliability and high image quality, and a method of manufacture for it.

### SUMMARY OF THE INVENTION

An image sensor chip package includes a base, an image sensor chip, a plurality of wires, an adhesive means and a cover. The base has a top surface and a plurality of top pads arranged on the top surface. The image sensor chip is mounted on the top surface of the base. The image sensor chip includes a photosensitive area and a plurality of chip pads around the photosensitive area. The wires electrically connect the chip pads of image sensor chip with their corresponding top pads of the base. The adhesive means is applied on peripheral edge of the image sensor chip, over the wires and covers areas where the wires connect with the chip pads. The cover is transparent and is mounted to the image sensor chip via the adhesive means. The cover seals the photosensitive area of the image sensor chip together with the adhesive means.

A method of manufacturing the image sensor chip package includes the steps of: providing a base, which includes a top surface and a plurality of top pads arranged on the top surface. Then an image sensor chip is provided, gluing the image sensor chip on the top surface of the base surrounded by the top pads, the image sensor chip including a photosensitive area on a top side thereof and a plurality of chip pads around the photosensitive area. A plurality of wires are then provided, which are then electrically connected at one end with a respective chip pad of the image sensor chip, and at an opposite end with a respective top pad of the base. An adhesive means is then provided and applied on a peripheral edge of the image sensor chip over the wires, the adhesive means covering areas where the wires connect with the chip pads. A transparent cover is then put on the adhesive means, covering the image sensor chip; and curing/fixing the adhesive means to secure the cover to the image sensor chip via the adhesive means.

Other advantages and novel features will become more apparent from the following detailed description when taken in conjunction with the accompanying drawings.

### BRIEF DESCRIPTION OF THE DRAWINGS

Many aspects of the present image sensor chip package can be better understood with reference to the following drawings. The components in the drawings are not necessarily drawn to scale, the emphasis instead being placed upon clearly illustrating the principles of the image sensor chip package. Moreover, in the drawings, like reference numerals designate corresponding parts throughout the several views.

FIG. 1 is a schematic, cross-sectional view of a typical image sensor chip package;

FIG. 2 is a schematic, cross-sectional view of an image sensor chip package according to a first preferred embodiment of the present invention; and

FIG. 3 is a schematic, cross-sectional view of an image sensor chip package according to a second preferred embodiment of the present invention.

### DETAILED DESCRIPTION OF THE PERFERRED EMBODIMENTS

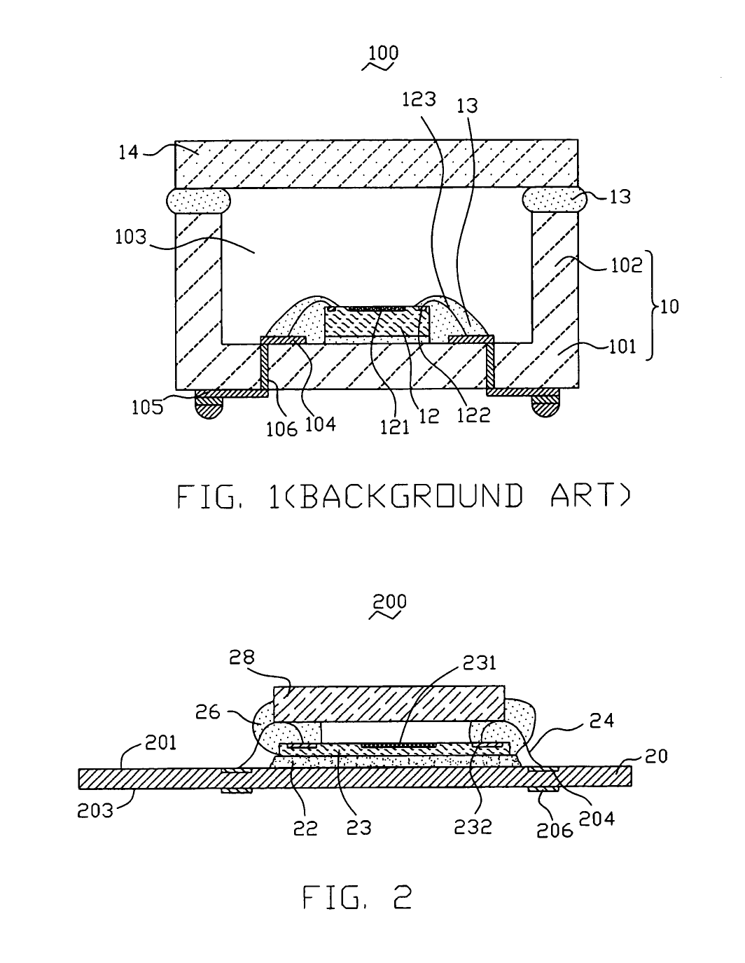

Referring to FIG. 2, an image sensor chip package 200 in accordance with a first embodiment of the present invention is shown. The image sensor chip package 200 includes a base 20, a first adhesive means 22, an image sensor chip 23, a plurality of wires 24, a second adhesive means 26 and a cover 28.

The base 20 is made of a material such as a plastic material, a ceramic material or a fibrous composite material. The base 20 has a top surface 201, a bottom surface 203 on an opposite side of the base 20 to the top surface 201, a plurality of top pads 204 and a plurality of bottom pads 206. The top pads 204 are circumferentially arranged on the top surface 201 of the base 20. The bottom pads 206 are circumferentially arranged on the bottom surface 203. Each bottom pad 206 corresponds to and electrically connects with a respective top pad 204. It is to be understood that the top pads 204 could also be embedded in the base 20, with a surface exposed to outside from the top surface 201, and the bottom pads 206 also could be embedded in the base 20 with a surface exposed to outside from the bottom surface 203. The bottom pads 206 are used to electrically connect with other electronic elements such as a PCB (printed circuit board).

The image sensor chip 23 is adhered to the top surface 201 of the base 20 via the first adhesive means 22 such as glue, surrounded by the top pads 204. A top side of the image sensor chip 23 is arranged with an photosensitive area 231 and a plurality of chip pads 232 around the photosensitive area 231.

The wires 24 are made of a conductive material such as gold or aluminum alloy. One end of each wire 24 is connected/joined with a respective chip pad 232 of the image sensor chip 23, and the other end of the wire 24 is connected/joined with a respective top pad 204 of the base 20.

The second adhesive means 26, such as a silicone, epoxy, acrylic, or polyamide adhesive, is applied to the peripheral edge of the image sensor chip 23, over the wires 24. The second adhesive means 26 covers areas where the wires 24 connect/join with the chip pads 232 so as to reinforce the connections/junctions of ends of the wires 24 with the chip pads 232.

The cover 28 is transparent and is laid over the image sensor chip 23 which receives light beams transmitted through the cover 28. A bottom surface of the cover 28 touches the top of each wire 34, thereby being supported by the wires 24. The cover 28 is adhered to the second adhesive means 26 and therefore seals the photosensitive area 231 of the image sensor chip 23 together with the second adhesive means 26.

A method of packaging the image sensor chip package 200 is disclosed by way of example, includes the steps of:

providing a base 20 having a top surface 201, a bottom surface 203 on an opposite side of the base 20 to the top surface 201, a plurality of top pads 204 arranged on the top surface 201 and a plurality of bottom pads 206 arranged on the bottom surface 203, each bottom pad 206 corresponding to and electrically connecting with a respective top pad 204;

cleaning the top surface 201 of the base 20, applying a first adhesive means 22 on the top surface 201 of the base 20, the first adhesive means 22 being surrounded by the top pads 204;

locating an image sensor chip 23 on the top surface 201 of the base 20 where the first adhesive means 22 is applied, the image sensor chip 23 including a photosensitive area 231 on a top side thereof and a plurality of chip pads 232 around the photosensitive area 231;

providing a plurality of wires 24, cleaning the wires 24 and electrically connecting one end of each wire 24 with a respective chip pad 232 of the image sensor chip 23, and an opposite end of the wire 24 with a respective top pad 204 of the base 20;

applying a second adhesive means 26 on the peripheral edge of the image sensor chip 23, over the wires 24, the second adhesive means 26 covering areas where the wires 24 connect/join with the chip pads 232;

providing a cover 28, cleaning the cover 28 and putting the cover 28 on the second adhesive means 26, above the image sensor chip 23, the cover 28 being pressed to touch the top of each wire 24; and

curing/fixing the second adhesive means 26 in order to fix the cover 28 to the second adhesive means 26 and seal the photosensitive area 231 of the image sensor chip 23.

In the first embodiment, the image sensor chip 23 is adhered on the top surface 201 of the base 20 without a side wall, thus there is no space restriction on the wire bonding tools' movements. Accordingly, the size of the base 20 can be sufficiently minimized to approach the size of the image sensor chip 23, and the volume of the image sensor chip package 200 can also be minimized. In addition, the photosensitive area 231 of the image sensor chip 23 is sealed by the second adhesive means 26 and the cover 28. Since the second adhesive means 26 and the cover 28 together form a space therebetween which is relatively small to contain relatively little dust and particles therein, the pollution and/or contamination of the photosensitive area 231 is reduced and the quality and reliability of the image sensor chip package 200 is much improved.

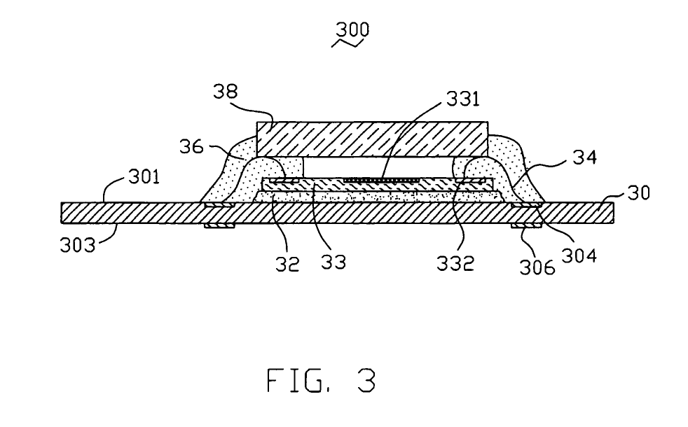

In a second embodiment of the present invention as shown in FIG. 3, an image sensor chip package 300 has a similar structure to the image sensor chip package 200. The image sensor chip package 300 includes a base 30, a first adhesive means 32, an image sensor chip 33 attached to the base 30 via the first adhesive means 32, a plurality of wires 34 electrically connecting the image sensor chip 33 with the base 30, a second adhesive means 36 and a cover 38 disposed over the image sensor chip 30 via the second adhesive means 36. The base 30 is configured to include a top surface 301 with which a plurality of top pads 304 are provided, and a bottom surface 303 with which a plurality of bottom pads 304 is provided. The image sensor chip 33 is constructed to have a photosensitive area 331 and a plurality of chip pads 332 arranged on a top side thereof. The difference between the image sensor chip package 300 and the image sensor chip package 200 is that the second adhesive means 36 is applied around the image sensor chip 33, and covers the whole of each wire 34, junctions of the wires 34 and chip pads 33, and junctions of the wires 34 and the top pads 304.

A method of packaging the image sensor chip package 300 is similar to the method of packaging the image sensor chip package 200 except for the step of applying the second adhesive means 36. In applying the second adhesive means 36, the second adhesive means 36 is provided around the image sensor chip 33 and covers the whole of each wire 34 and areas where the wires 34 connecting with the chip pads 33 and the top pads 304.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. An image sensor chip package comprising:
a base comprising a top surface and a plurality of top pads arranged on the top surface;
an image sensor chip mounted on the top surface of the base, the image sensor chip comprising a photosensitive area and a plurality of chip pads around the photosensitive area;
a plurality of wires each electrically connecting one of the chip pads of the image sensor chip with a corresponding one of the top pads of the base;
an adhesive means applied on peripheral edge of the image sensor chip, over the wires, the adhesive means covering areas where the wires connecting with the chip pads; and
a transparent cover mounted to the image sensor chip via the adhesive means, the cover together with the adhesive means sealing the photosensitive area of the image sensor chip.

2. The image sensor chip package as claimed in claim 1, wherein the base further comprises a bottom surface opposite to the top surface and a plurality of bottom pads arranged on the bottom surface, each bottom pad corresponds to and electrically connects with a corresponding top pad.

3. The image sensor chip package as claimed in claim 1, wherein the adhesive means further covers the whole of each wire and covers areas where the wires connects with the top pads of the base.

4. The image sensor chip package as claimed in claim 1, wherein the cover comprises a bottom surface touching the top of each wire.

5. A method of manufacturing an image sensor chip package, comprising the steps of:
providing a base, which comprises a top surface and a plurality of top pads arranged on the top surface;
mounting an image sensor chip on the top surface of the base, surrounded by the top pads of the base, the image sensor chip comprising a photosensitive area on a top side thereof and a plurality of chip pads surrounding the photosensitive area;
providing a plurality of wires, electrically connecting one end of each wire with a respective chip pad of the image sensor chip, and an opposite end of the wire with a respective top pad of the base;
applying an adhesive means on the peripheral edge of the image sensor chip, over the wires, the adhesive means covering areas where the wires connect with the chip pads;
placing a cover on the adhesive means, above the image sensor chip; and
curing the adhesive means to secure the cover to the image sensor chip via the adhesive means.

6. The method as claimed in claim 5, further comprising a step of cleaning the cover before placing the cover on the adhesive means.

7. The method as claimed in claim 5, further comprising a step of pressing the cover to a bottom surface thereof touching the top of each wire after putting the cover on the adhesive means and before curing the adhesive means.

8. The method as claimed in claim 5, wherein the base further comprises a bottom surface opposite to the top surface and a plurality of bottom pads arranged on the bottom surface, each bottom pad corresponds to and electrically connects with a respectively corresponding top pad.

9. The method as claimed in claim 5, wherein the adhesive means further covers the whole of each wire and covers areas where the wires connects with the top pads of the base.

10. A chip package comprising:
a base comprising a top surface and a plurality of top pads arranged on the top surface;
a chip mounted on the top surface of the base, the chip comprising a plurality of chip pads;
a plurality of wires each electrically connecting one of the chip pads of the image sensor chip with a corresponding one of the top pads of the base;
a cover located in contact with the wires; and
an adhesive joining the chip and the cover and applied over the wires.

11. The chip package of claim 10, wherein the chip is an image sensor chip, and the cover is transparent.

12. The chip package of claim 10, wherein the adhesive covers junctions of the wires and the chip pads.

13. The chip package of claim 10, wherein the adhesive covers whole portion of the wires.
